(19) United States
(12) Patent Application Publication
(10) Pub. No.: US 2011/0010535 A1
(43) Pub. Date: Jan. 13, 2011

(54) MULTI-MEDIA DIGITAL CARTRIDGE STORAGE AND PLAYBACK UNITS BACKGROUND OF THE INVENTION

(76) Inventors: Kenneth Nelson, New York, NY (US); Warren Melnick, Huntington Station, NY (US)

Correspondence Address: TUTUNJIAN & BITETTO, P.C., 20 CROSSWAYS PARK NORTH, SUITE 210, WOODBURY, NY, 11797, US

(21) Appl. No.: 12/884,444

(22) Filed: Sep. 17, 2010

Related U.S. Application Data
(62) Division of application No. 10/719,413, filed on Nov. 21, 2003, now abandoned.

(51) Int. Cl. H04L 9/00

(52) U.S. Cl. 713/150

(57) ABSTRACT

A method and apparatus for playing back a digital media file. The invention comprises defining a plurality of predetermined media types based upon an advertising scheme associated therewith, and valuing each of the plurality of predetermined media types in accordance with the advertising scheme. Then, one of the plurality of media types is selected and played back, thus invoking the associated advertising scheme.

### CROSS-REFERENCE TO RELATED APPLICATIONS

This application is a divisional application of co-pending U.S. patent Ser. No. 10/719,413 on filed Nov. 21, 2003, which is incorporated by reference herein in its entirety.

### BACKGROUND OF THE INVENTION

This invention is related generally to a digital cartridge and console player supporting universal connections, access protocols, and playback of media through all current and future consumer electronic devices with various layers of security, allowing for protection for the copyright owner as well as preservation of the rights of the consumer. Because of the advances in digital storage and compression, all forms of data will need to be stored digitally and people will need a central place to store and access all of this data securely and to allow some access of this data to others. Therefore, it would be beneficial to provide a console whose design supports ALL forms of connectivity to existing and future devices and allows viewing, listening and transfer to and from these devices as well as the security needed to make both the user and the copyright holder comfortable. It would also be beneficial to provide a new form of digital media packaging, pricing and security that is supported by advertising and sponsorship so that a content owner can receive appropriate compensation for the data.

### SUMMARY OF THE INVENTION

Generally speaking, in accordance with the invention, an improved method and apparatus are provided for storage of digital data with a full Digital Rights Management scheme, preserving intellectual property rights for both the copyright owner and the consumer, allowing various advertising models for software (movie, audio, game) purchases, and to support the after-purchase sale or barter of original digital media purchased files to other users and/or organizations.

As copyright holders want to release their Intellectual Property for sale or rental in the digital domain and as consumers want to move their personal data into the digital realm, there becomes a need for a device and system of distribution that will allow for the storage and viewing of these data in their various formats, and also include safeguards for securing the rights of the copyright holders and those to whom the data belongs.

At the present time, digital data may be stored on compact discs (CDs), digital versatile discs (DVDs), in personal computers, consumer electronic devices containing fixed or other storage or on computer networks. This data is generally minimally encrypted and can only be accessed on the player for the specific medium on which it is stored. Each of these media may only contain a limited format of the data, which is to be presented. For example, DVDs in the United States must contain video in the resolutions of 352×240, 352×480 or 720×480 and be compressed using the MPEG-1 (352×240) or MPEG-2 (nnn×480) algorithms, which are effectively obsolete by today's standards, but are industry-standard for movie distribution today. Similarly CDs are 16-bit 44.1 khz uncompressed audio using technology that is 20 years old. Compact discs have no encryption at all and the encryption for DVDs was rendered useless years ago as well.

Additionally CDs are sold without any on-disc advertising at all and DVDs are limited by the advertising that is mastered onto the disc at the time of creation, allowing for no flexibility after-the-fact, and often allow users to skip the viewing of this advertising. The players for these media tend to be stand-alone units and are only connected to amplifiers and video displays for listening and viewing.

If the user wants to buy additional programming, another piece of physical media must be purchased and either picked up by or shipped to the user. Each time the user buys another piece of programming (movie, album, etc) they are the sole person who knows that they own this particular piece of programming and are responsible for keeping any receipts of the purchases that they have made. Should the physical medium become damaged, the user must buy another, or contact the distribution company and arrange for a replacement. Owners may legally sell, trade, rent or barter the original purchased physical media. Under this premise, all back-up copies made by the owner, legally must be destroyed by the owner in order to abide by various US copyright laws. This is very difficult to enforce as it solely relies on the honesty of users to destroy copies made of media—and due to the high penetration and ease of duplicating digital media files, media content and copyright owners continue to lose sales and revenue due to illegal copies of digital media being sold and/or traded through file sharing applications. The results of such illegal copying has been well documented lately.

Thus, the ability for illegal copying, and the skirting of copyright laws, has been made much more substantially difficult with the advent of digital technology. Rather than analog technology where each copy results in the degradation of quality, digital copies are exact replicas. The posting of such a digital copy on the Internet, or the distribution of such copies by email results in multiple identical copies from the same digital original. Currently, there is no method and apparatus in the art for restricting use of a particular digital media to a particular user or playback apparatus.

Currently, pricing for a piece of digital media (audio/video) is based upon the purchase of a physical medium (i.e.: CD or DVD disc). The purchased physical media allows users skip to tracks or sections of the featured media file(s). This form of media does not contain any forced advertising or supplemental content that requires the buyer to view/hear prior to having access to the central media files that justified the purchase. In some cases, such as VHS rentals, some advertising is located on the media prior to the main feature—and users “have the choice” of watching/hearing this content or fast-forwarding to the beginning of the featured media. In accordance with the invention of the digital cartridge and console player, a proprietary media file format and digital asset packaging and pricing scheme has been created to offer consumers pricing choices with regard to similar digital media in which “forced” advertisements or sponsored content would be included within certain purchase/pricing types.

### BRIEF DESCRIPTION OF THE DRAWINGS

FIG. 1 is a block diagram depicting an apparatus for recording and replaying various digital media content;

FIG. 2 is a flowchart depicting a method by which various levels of advertising provided with a particular purchased digital media are distinguished;

FIG. 3 is a diagram depicting a CAC media file for management of recording and replaying digital media content; and

FIG. 4 is a diagram depicting the management of the purchase, provision and distribution of digital media and data.

### DETAILED DESCRIPTION OF THE PREFERRED EMBODIMENTS

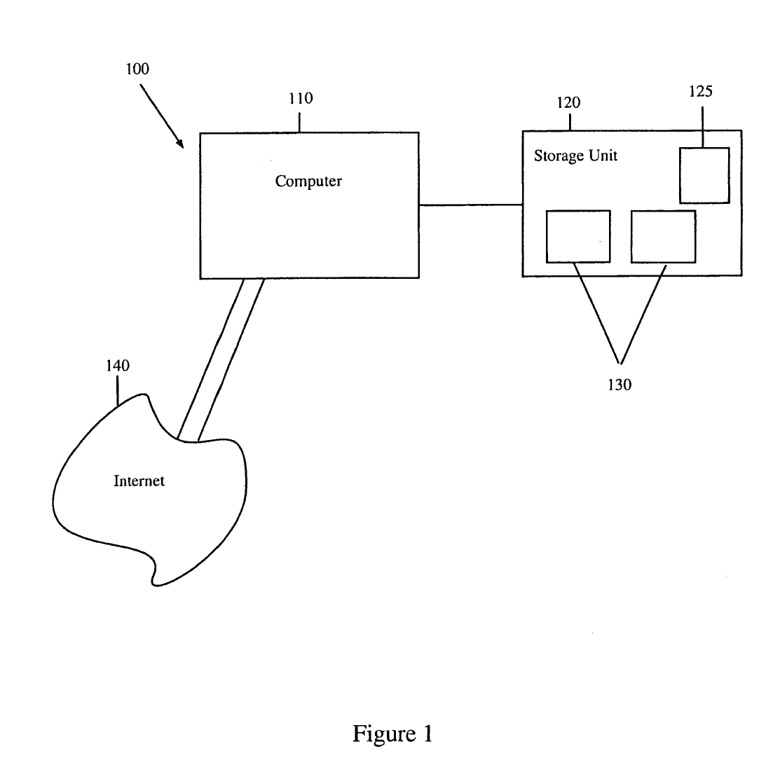

Referring first to FIG. 1, a recording and replay apparatus 100 is shown. Apparatus 100 comprises a standard or specialized computer 110, and a storage unit 120. Storage unit 120 further comprises fixed storage media 125 and removable storage media 130. Computer 110 is also connected via the Internet 140 to various media provision sites. Apparatus 100 may comprise a standard desktop computer, or may comprise a set top box, including the storage unit and Internet connection therein.

During use, a user may download various digital content via Internet 140 and store this content on fixed storage media 125 or removable storage media 130. Alternatively, a user may purchase additional removable storage media 130 including the digital content thereon. Upon the insertion of such a storage medium into storage unit 120, the digital content may be replayed or the retrieval of content from fixed storage 125.

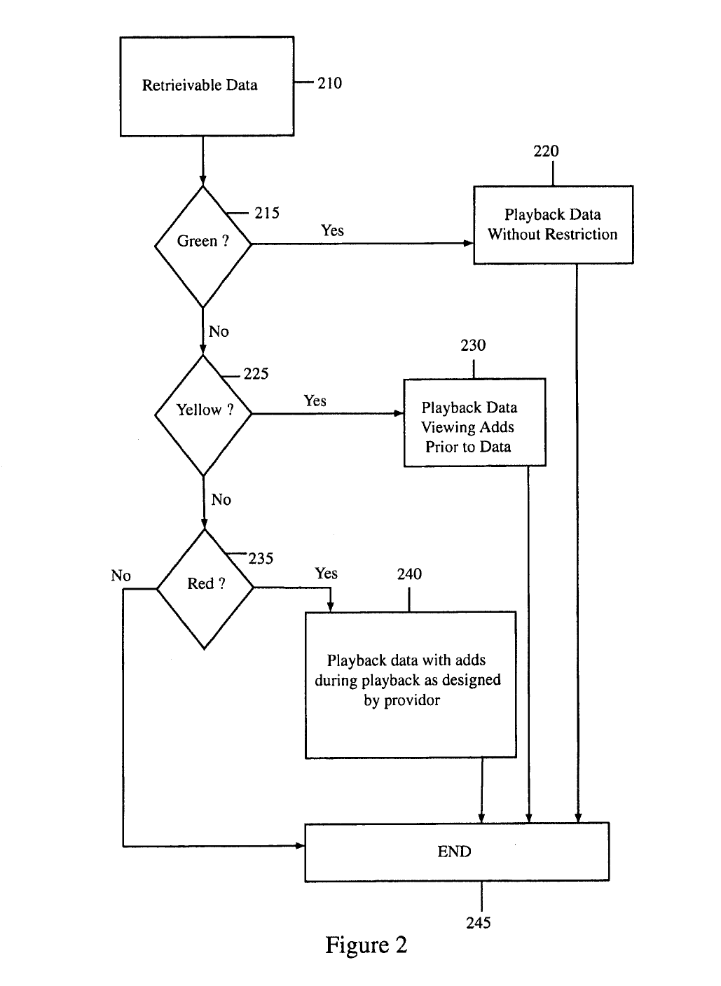

Referring next to FIG. 2 of the invention, consumers will have the option of purchasing or renting one of multiple types of CAC media file formats. These formats relate to the way advertising is included with the digital data, and pricing to a user based thereupon. Of course, any number of types of formats may be employed. These formats are based upon the type of advertising, included therein. Whether or not a discount is applied, and the amount of the discount is based on the type of file format selected. As shown at step 210, a data file is retrieved. Then, at step 215, it is determined whether the file indicates that a discount should not be applied.

A “clean” file, having no retail discount applied, will be referred to as a “Green” file. These files only contain the raw media file and no sponsor or ad related material. These files are similar to CD/DVDs sold in the current marketplace. If it is determined that the file is a green file, the data is played back without restriction in step 220. The process then proceeds and ends at step 245.

If it is determined at step 215 that the file is not a green file, control passes to step 225 where it is determined whether the file is formatted for a partial discount with some forced advertisement. The partial format file solution will be referred to as a “Yellow” file.

A Yellow file is a “Sponsored” file with a partial consumer discount (i.e. 10%-20% retail discount applied to purchase/rental)—These files include sponsor or ad related content that MUST be played/viewed prior (beginning) to the raw media file and/or at another time in within the playing time of the media file(s). The sponsor/ad time allotted on these files is based on 5% to 10% of the total time of the actual media file. For example, a 2-hour movie would have approximately 6 to 12 minutes (5%-10%) of forced sponsor/ad media played each time this media file is played or viewed.

If it is determined at step 225 that the file is a yellow file, then at step 230 the data is played back, along with the required advertisement segments. Any desired number of advertisements or segments may be employed. Thereafter, control passes to step 245 and playback ends.

If it is determined at step 225 that the file is not a Yellow file, control passes to step 235 where it is determined whether the file is formatted for the highest level of sponsor time. This file will be referred to as a “Red” file.

A Red file is a “Budget” file (i.e. 30%-100% retail discount applied to purchase/rental). These contain sponsor or ad related content that MUST be played/viewed at any time specified by the content owner along with the raw media file. The sponsor/ad time allotted on these files is based on 10% to 35% of the total time of the actual media file.

If it is determined at step 235 that the file is a Red file, then control passes to step 240 where the file is played back with the required advertising information therein. Control then passes to step 245 and playback ends.

If at step 235 it is determined that the file is not a Red file, then it is determined that the file is a non-compliant file, control passes to step 245 and ends and playback is prohibited.

There are at least two types of ads that may be provided.

1) Static (Fixed for Lifetime of File).

Since these will not change over the life of the file, they are transferred to the cartridge along with the file and will remain with the file during any subsequent transfers (sales) of the file to other owners.

2) Dynamic (Through Ad Server).

Ad server advertisements are targeted toward the user himself based on either a demographic information survey that the user has filled out or based upon the viewing habits of the user as determined by the computer unit. These ads may be downloaded by computer 110 via Internet 140 as shown in FIG. 1.

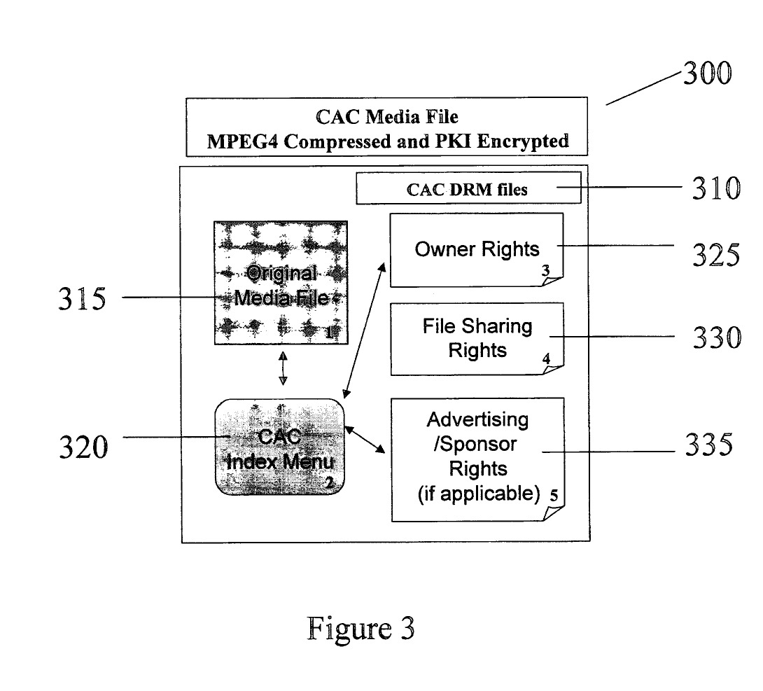

Referring next to FIG. 3, a CAC media file 300 constructed in accordance with the invention is shown. Such a CAC type of file is distributed to a user and includes not only the content data, but various file sharing rights, digital rights management and advertising information. As is shown in FIG. 3, media file 300 includes an original media file 315 containing the information of the audio or video information that is provided by a content generator or content provider. Also included are CAC digital rights management (DRM) files 310 which are used to ensure that the copyright of the original media file 315 is honored. Also shown is a CAC index menu 320 created which is used for properly administering CAC media rights. In addition to operating in accordance with the DRM files 310, the CAC index menu further operates upon owner right files 325, file sharing right files 330 and advertising sponsor rights files 335 if applicable. In this manner, the index menu controls access to the original media file 315 through the use of the other various information.

As is further shown in FIG. 3, a CAC media file encryption system is able to support and encrypt all forms and all types of digital media and data files such as, but not limited to, CD, DVD, MB3, AVI, MPEG 2 and 4, as well as any other digital medias formats that may arise in the future. This is possible because the CAC media file is not original media file format dependent, and therefore any original media file format may be incorporated into the CAC system. Additionally, the CAC DRM files 310 may be customized and edited based on the type of media that an original media file owner or generator is distributing. Thus, for example, for a copyrighted song, digital rights files may be somewhat restricted, while other information may be desired to freely distribute, such as promotional pieces or the like.

Once the DRM files and original media file have been designated, the original media file is encrypted and compressed, and is uploaded along with a CAC index menu file 320 and the digital rights management files 310 defined by the user to a CAC content distribution server (as will be described below). This information, including the index menu DRM files and original media file are then once again encrypted to form a final CAC media file, that is downloaded to a digital tape or other storage device for future video viewing and playing back.

The CAC index menu 320 is a proprietary map or menu including links for the management of the associated media file or files. Essentially the CAC index menu describes to a CAC compatible hardware console player by whom, and how the particular original media file associated with the CAC media file should be played back, the number of tracks and indexes, immediate format options, advertising and the like. The determination of the advertising formats and the like is defined at the point of sale, or other transfer transaction. As noted above, the DRM settings are based upon desirability of the owner and associated purchase and/or rental options.

Upon purchase of a media file by a user, a unique CAC file ID is created and assigned within the associated CAC index menu file and is registered with CAC's DRMA (Digital Rights Management Association) network, as will be described below. Thus, not only each media file, but each copy of each media file is provided with a separate file identification ID so that the DRMA network can identify the particular copy purchased by a particular user. The DRMA is a central database on a CAC network which tracks all buy/sell and trade transactions of all CAC media.

Owner rights file 325 provides a variety of properties that are determined by the type of purchase or rental and rights assigned by the content provider. This section contains a list of all the associated CAC accounts that are allowed to view/play this particular media. Thus, if a user purchases a CAC media file for personal use, only an identified player of the particular user may be allowed to play back the data. However, if a number of copies are also purchased, other players may also be entitled to play this media file. Additionally, file sharing rights 330 allows for a content owner to provide an original purchaser with rights for sharing the media. Thus, a user may be allowed to share lower quality formats, or any copies may be provided with additional advertising to offset the loss in revenue from the sharing of the media. The sharing rights are defined in section 330 by a provider of the media files.

The advertising sponsor rights 335 section is directly linked to the owner rights and file sharing rights noted above. The advertising rights refer to specific types of ads/sponsor media that the content owner would like associated with their media file and whether they would like the CAC advertising network to assign ad sponsor media to the file based on the type of file purchased. As is noted above, based upon the type of purchase, the advertising sponsor rights may define green, yellow or red advertising, or any other scheme desired by a user. If advertising is selected, it may be necessary for a provider to define where a particular advertising should show, and on which copies of media they might show. Specific playback of the defined color files noted above will now be described.

Thus, for example, with the “yellow” or partial discount option content owners will also be able to select where they would like to ad/sponsor media to appear in their media file.

As noted above, while a green file is a standard playback, yellow and red files have some limitations, as will now be more fully described.

Yellow

a) Random Access

Any attempt to reverse or forward into a given segment of time after an advertising block jumps to the beginning of that advertising block. This stops people from leaving the room during advertising and just backing up to the end of the ads if they were not paying attention.

b) Intermission Point(s)

The studio defines a point within a movie for the intermission ad in a yellow movie. If individual scenes are being watched (random access) in a movie, the viewer will still receive the second set of advertising after that amount of viewing time if they have not seen the ads already by passing through the ad trigger time. For example:

1) One Point for a Two-Hour Movie

It will be an enforced protocol that any movie two hours long shall have only one intermission point. This point will be determined by the studio, but should be roughly halfway through the movie.

2) Additional Points for Longer Movies

For each hour over two hours, an additional intermission point may be defined by the studio. Again, these intermission points should be spread evenly throughout the media file.

c) Subscription Services

For a monthly fee a user can have access to a given library of movies flagged as “Yellow” for advertising purposes, but also flagged as “Subscription” so that they might not be sold.

Red

a) Random Access & Subscription Service

Jumping around within a file will play the previous ad section in the file if one or more ad sections were jumped over to get to the new point. Thus, an ad is associated with each segment of the file, and must be played, whether a user is viewing, fast forwarding or reversing through the section.

The data available for purchase, in accordance with the DRM scheme, shall include embedded co-marketing ventures such as advertising and sponsored content to allow offsetting of the costs. Such markings can be placed into the cartridge itself as well as in the data. Such advertising may also be used to offset the costs of the cartridge itself (if the data is sold on a hard removable storage medium) and allow such industries as should be interested to sponsor a cartridge by presenting advertising to the user whenever that cartridge is used or to have a reserved area of the data cartridge to store their own content. All cartridges are formatted to support at least 10% of reserved content storage in which the wrote access is solely controlled by either the cartridge “sponsor” or network provider.

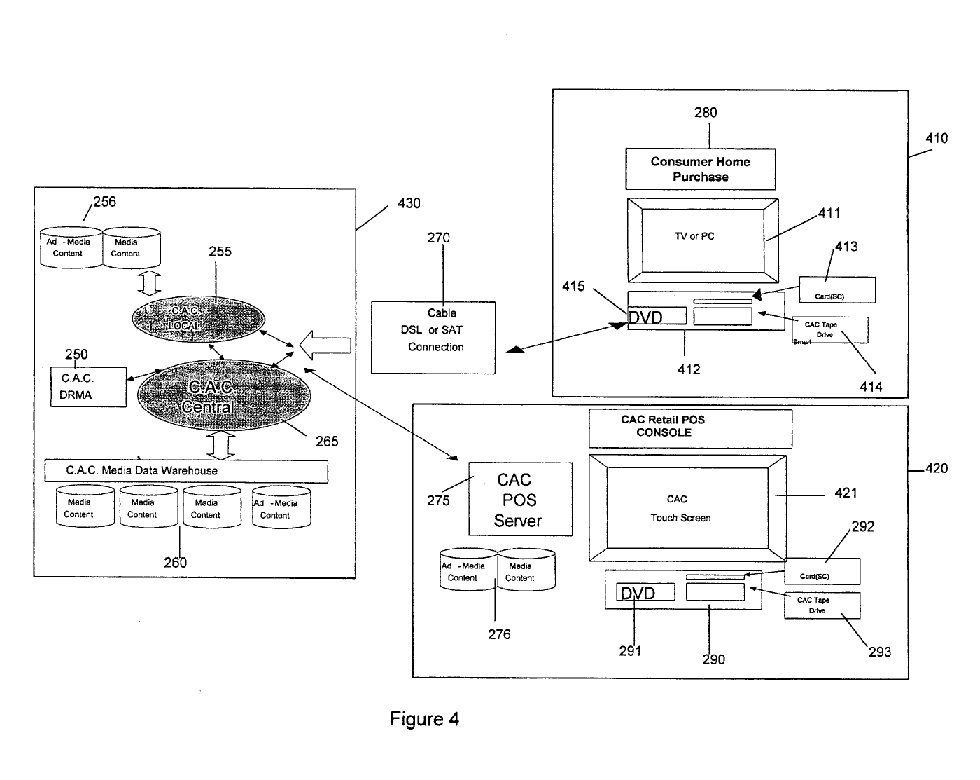

In accordance with these cartridges, there shall be mechanisms for Point Of Sale kiosks or machines that shall be able to sell a piece of data such as a movie or a song to the owner of a cartridge at varying prices depending on the “color” of the data as made available by the owner, with its expectation that “Green” data shall cost the most, “Yellow” shall be sold at a discount and “Red” to be sold at the greatest discount or even given away with the expectation that the co-marketing revenue shall make up the lost sales revenue. Once the sale has been completed, the sale shall be registered with the DRMA and the data properly copied and encrypted to the cartridge. See FIG. 4. Thus, if a data is destroyed, a user is able to obtain an additional copy as he or she is the registered user. Additionally, the registration generates a registration number that is embedded with the data. It is within the scope of this invention that any playback device confirms that only the appropriate user playback the data by checking with a central DRMA before each playback. See FIG. 4. Thus, the replay apparatus would be similarly registered with a particular user. Only a data and a player registered to the same user will allow playback.

For a user to transfer ownership of the data, the storage media can be physically moved, but the transfer must also be registered so that the ownership of the data and the new owners replay apparatus will match.

In this manner, a method and apparatus are provided that allow for the distribution of various advertising data along with digital content, and a user choice for determining how much to pay for a digital data based on a predetermined level of acceptable advertising.

Additionally, data may be purchased by the user in some other manner such as over the Internet or by phone and be downloaded to the player via one of its many connections such as Ethernet, for once a sale is registered with the DRM authority, the user shall always have access to the data.

Additional connectivity shall be provided by the player to allow for data to be moved to and from legacy recorders and players. Such data shall only be made available for playback and storage. If the user wishes to sell/transfer this content to other users, the content must be registered and approved by the central DRMA.

Referring next to FIG. 4, a CAC DRMA network is shown. The network is comprised of three general components. First provided is a central storage and management network 430, which stores all ad content, media content and administers the various digital rights management components of the system. Also provided is a home purchasing and viewing location 410 and a retail point of sale console 420. As is further shown in FIG. 4, central system 430 comprises a central database 265 for administering the entire data processing system. Database 265 is provided with further access to a CAC media data warehouse 260 including various media content and advertising content. Also provided may be one or more various local networks 255 each including its own media and advertising content 256 for a more localized and less centrally administered system. Such a split system may increase speed of access and availability to data media for particular users. Also provided is a digital rights management association database 250 which ensures digital rights management system is properly implemented.

In accordance with the invention, a user at a home system 410, comprising a television or PC, and a CAC hardware TV or PC 411 and a CAC hardware player 412, scans and purchase various CAC media via the Internet, utilizing a broadband or other appropriate Internet connection 270. When a CAC media is downloaded, the CAC media information may be stored on, or by, a smart card 413, a tape drive 414, a DVD drive 415 or any other appropriate storage media.

As an alternative to purchasing media at home, a user may purchase such media at a retail console 420 comprising a touch screen 421, a CAC media recorder and player 290, comprising a DVD 291, a smart card drive 292, a tape drive 293, or other storage apparatus for other removable media as is appropriate. The retail point of sale console is very similar to the home purchase device except it includes a point of sale server 275 which provides a cache 276 for, for example, local ad media content, ad content and media content that may be requested multiple times by a user, or which may be local to only a particular area or store.

During operation, when a user requests or purchases a particular CAC media, a type of media desired may be indicated, if given a choice, such as a green, yellow or red file as noted above. The various settings in the CAC media file as shown in FIG. 3 are appropriately determined, and an identification ID is assigned to the particular piece of media. This identification is registered in the CAC DRMA system 250. Once registered, the CAC media file is transferred to the home purchase location 410 or retail point of sale location 420, and provided on an appropriate storage device for a user. The user is then free to make use of this media file as defined in the digital rights management system of FIG. 3. Thus, if a user is entitled to view the media at home, the media is viewed, and any forced advertising in accordance with discounts applied as noted above are implemented.

If a user wishes to transfer the media file to another user, the sale transaction must take place and the CAC central network 430 must be notified. In the case of such a transfer or sale, the identification associated with the particular CAC media file is transferred ownership so that the new owner has the rights to view this file. If the media file is simply transferred without registration, a check with the centralized system upon an attempt to playback the media file will indicate that the user attempting to playback the media does not have the rights to do so, and media playback will be thwarted. In this manner, because each media contains a separate identification, it may be individually tracked, and multiple copies of a single device will not be effective because the digital rights management system will stop the user from playing back the information unless they are authorized. Therefore, In combination with the CAC Data Warehouse, Settlements Processing including the DRMA and payments management component will control, authorize, and protect the retail sales and rentals for distribution (step 250). DRMA partner financial institutions will only have access to their customer's purchase and sale transactions. CAC will act is an independent intermediary in the event of a disputed transaction.

As is further shown in FIG. 4 the next process is distribution of media based on the management of file and purchase information management. In steps 255 and 260 digital media with sponsor or advertisement content as appropriate is formatted to step 265 to the central and/or local CAC NOC and managed in step 250 by the DRMA. Transactions on the CAC Network allow CAC members to purchase or rent media through at least two types of mediums: 1) Direct-console at home location with a broadband connection 2) Indirect-retail store with a CAC Point of Sale (POS) Kiosk.

For direct home purchases the transmission of CAC DRM files and purchase information to the CAC Local NOC (if applicable), then finally to the CAC Central NOC occurs following step 265 in step 270 to step 280. For step 280 the direct home purchase will allow interaction with the central and/or local CAC NOC to pull fo matted digital media with sponsor or advertisement content as appropriate. The formatted digital media or data is sent to the consumer at home location.

For indirect retail purchases, following step 265 is step 275 with the CAC POS server connection to step 290 to transmit CAC DRM files and purchase information to retailer. The indirect retail purchased digital medium will also be retrieved central and/or local CAC NOC, but predetermined media and data will also be stored locally in a fast readily accessible manner. Data storage reduces time for file preparation. The formatted digital media or data, with sponsor or advertisement content as appropriate, is sent to the Retail CAC POS and retailer.

1. A system for distributing media files, comprising:
means for associating a media file with one or more management information;
means for assigning a unique ID to said media file and associated management information;
means for encrypting said media file, management information and unique ID;
means for generating a database for associating each unique ID with a particular user who is permitted to process said media file;
whereby upon a transfer of said media file to another individual, said database is updated so that said unique ID associated with said transferred media file is registered to said other individual.

2. The system of claim 1, wherein upon said transfer of said media file to another individual, a forced advertising associated with said media file is changed.

3. A recording media upon which a media file is recorded, said media file being generated in accordance with the steps of:
associating a media file with one or more management information;
assigning a unique ID to said media file and associated management information;
encrypting said media file, management information and unique ID;
generating a database for associating each unique ID with a particular user who is permitted to process said media file;
whereby upon a transfer of said media file to another individual, said database is updated so that said unique ID associated with said transferred media file is registered to said other individual.
